(19) United States
(12) Patent Application Publication
(10) Pub. No.: US 2005/0027722 A1
(43) Pub. Date: Feb. 3, 2005

(54) Method and apparatus for outputting specific information by functional-key instruction via output apparatus

(76) Inventor: Chen-Liang Huang, Taichung (TW)

Correspondence Address: BIRCH STEWART KOLASCH & BIRCH, PO BOX 747, FALLS CHURCH, VA, 22040-0747, US

(21) Appl. No.: 10/891,145

(22) Filed: Jul. 15, 2004

(30) Foreign Application Priority Data
Jul. 17, 2003 (TW) 92119513

(51) Int. Cl. G06F 17/00

(52) U.S. Cl. 707/100

(57) ABSTRACT

A method for outputting specific information via an output apparatus by functional-key instruction is provided. The output apparatus includes a network connection device, a processor and an output unit. The output apparatus connects through network to a database having specific information. The processor connects to the network connection device and the output unit respectively. The method includes: (a) fetching the specific information from the database by using the network connection device after receiving an functional-key instruction ; (b) transmitting the specific information to the processor; (c) transmitting the specific information to the output unit to output the specific information.

### CROSS REFERENCE TO RELATED APPLICATIONS

This Application claims priority to Taiwan Patent Application No. 92119513 entitled “Method and Apparatus for Outputting Specific Information by Functional-key Instruction via Output Apparatus,” filed Jul. 17, 2003.

### FIELD OF THE INVENTION

The present invention relates to a method and an apparatus for outputting specific information, and more particularly, by functional-key instruction via an output apparatus.

### BACKGROUND OF THE INVENTION

People can fetch information they need via many ways nowadays. In recent years, especially, network media has grown fast and become a mainstream media of the new age. So, how to select and output the abundant information by paper has become an important issue to many people.

In conventional skills, users usually output information by a computer with a printer, and users have to search, to select, to typeset and to print manually. It takes much time and a lot of manpower and requires cooperated hardware.

For this reason, the present invention provides a method to output specific information by an output device, helping users get information they need quickly and deal with huge amount of information.

### SUMMARY OF THE INVENTION

The present invention provides a method of outputting specific information by functional-key instruction via an output apparatus. The method provides a convenient way to deal with and output information.

The mentioned method includes: (a) fetching the specific information from the database by using the network connection device after receiving an functional-key instruction; (b) transmitting the specific information to the processor; (c) transmitting the specific information to the output unit to output the specific information.

The present invention also provides an output apparatus for users to fetch and output specific information.

The mentioned output apparatus includes a network connection device, a processor and an output unit connecting to the processor. Foregoing components connect one another via network and the output unit outputs the specific information responsive to an instruction from a user.

### BRIEF DESCRIPTION OF THE DRAWINGS

FIG. 1 shows a system block diagram of the output apparatus of the present invention.

FIG. 2 shows a flow chart of the method of outputting specific information by functional-key instruction of the present invention.

FIG. 3 shows a schematic diagram of the embodiment of the present invention.

FIG. 4a shows a schematic diagram of another embodiment of the present invention.

FIG. 4b shows a schematic diagram of the software interface of the functional-key instruction setting in the embodiment of FIG. 4a.

FIG. 5 shows a schematic diagram of another embodiment of the present invention.

### DETAILED DESCRIPTION OF THE INVENTION

The present invention provides a method of outputting specific information by an output apparatus 101. The output apparatus 101 can be a multi-function printer or other embodiments with the same function.

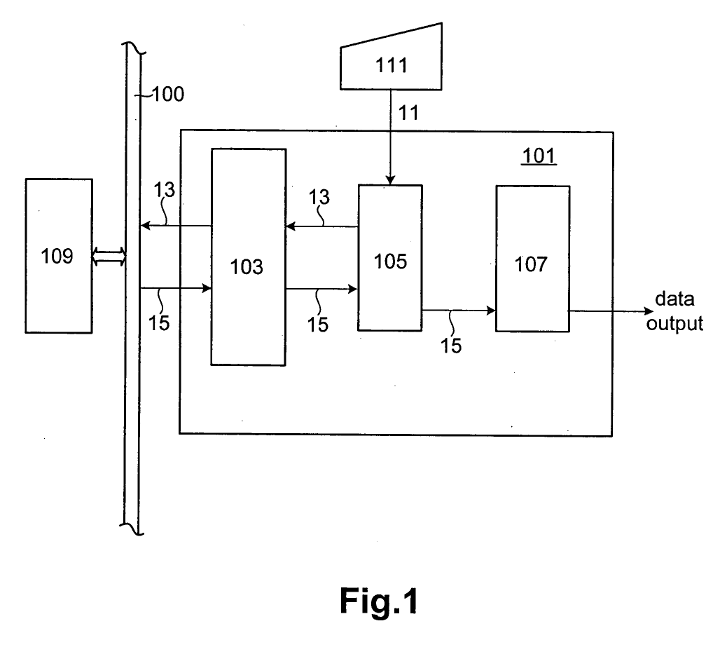

FIG. 1 shows a system block diagram of the output apparatus of the present invention. As shown in FIG. 1, the output apparatus 101 includes a network connection device 103, a processor 105 and an output unit 107. The network connection device 103 connects to a database 109 storing specific information 15 via a network 100. The network connection device 103 connects to the processor 105 in the output apparatus 101. The processor 105 connects to an external input interface 111 and connects to the internal output unit 107. The network connection device 103 can be a network card, a modem or other apparatuses with network connection function. The database 109 selectively connects to the Internet and the intranet and has the pre-processed and classified specific information 15 for users to directly output after selection. The input interface 111 receives a functional-key instruction from a user and initiates the processor 105 to proceed with the information output task.

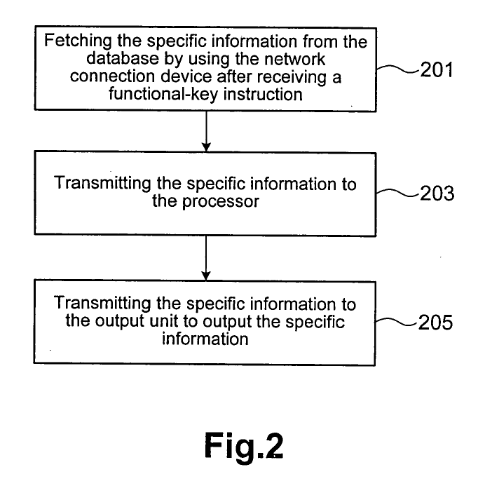

FIG. 2 shows a flow chart of the method of outputting specific information by functional-key instruction of the present invention. As shown in FIG. 2, first of all, process the step 201, fetching the specific information 15 from the database 109 by using the network connection device 103 after receiving a functional-key instruction 11. Users can output the specific information 15 rapidly by the functional-key instruction 11. Second, process the step 203, transmitting the specific information 15 to the processor 105. Finally, process the step 205, transmitting the specific information to the output until 107 to output the specific information 15.

Referring to FIGS. 1 and 2, detailed methods are described as follows. A user inputs a functional-key instruction 11 to the processor 105 of the output apparatus 101 via input interface 111. The processor 105 receives the functional-key instruction 11 and transmits an instruction 13 to the database 109 through the network connection device 103 and network 100. The database 109 receives the instruction 13 and transmits the specific information 15 to the network connection device 103 via network 100. After the processor 105 performs an operation over the specific information 15, the specific information 15 is transmitted to the output unit 107 to output.

The mentioned operation over the specific information 15 by processor 105 includes characters and images arrangement and copies selection. Through the operation, users can choose the print form of the specific information 15. The processor 105 can be saved in the output apparatus 101 as a firmware. Users can select one of predetermined scenarios to output the specific information. In other embodiments, the processor 105 can be in a form of software.

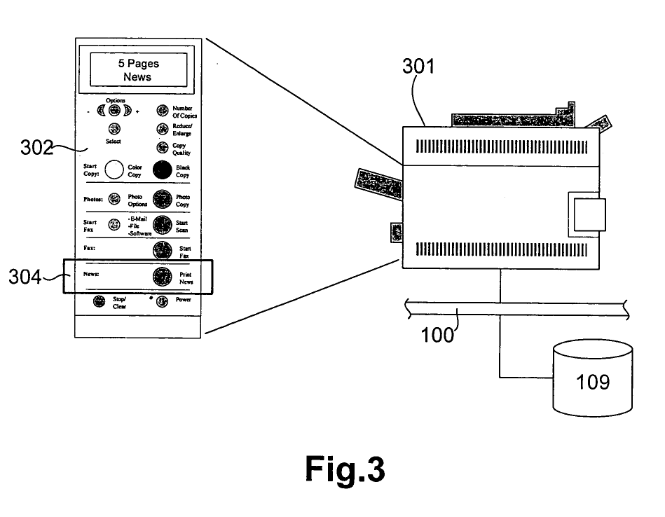

FIG. 3 shows a schematic diagram of the embodiment of the present invention. The output apparatus 101 here is a multi-function printer 301 with the network connection device 103 and the processor 105. The multi-function printer 301 connects to the database 109 storing specific information 15 via network 100. The database 109 selectively connects to the Internet and intranet. The control panel 302 includes a keystroke 304 for printing the news on certain web pages (predetermined) following the steps in FIG. 2. After setting the control panel 302, users can press the keystroke 304 to print the specific information 15 directly.

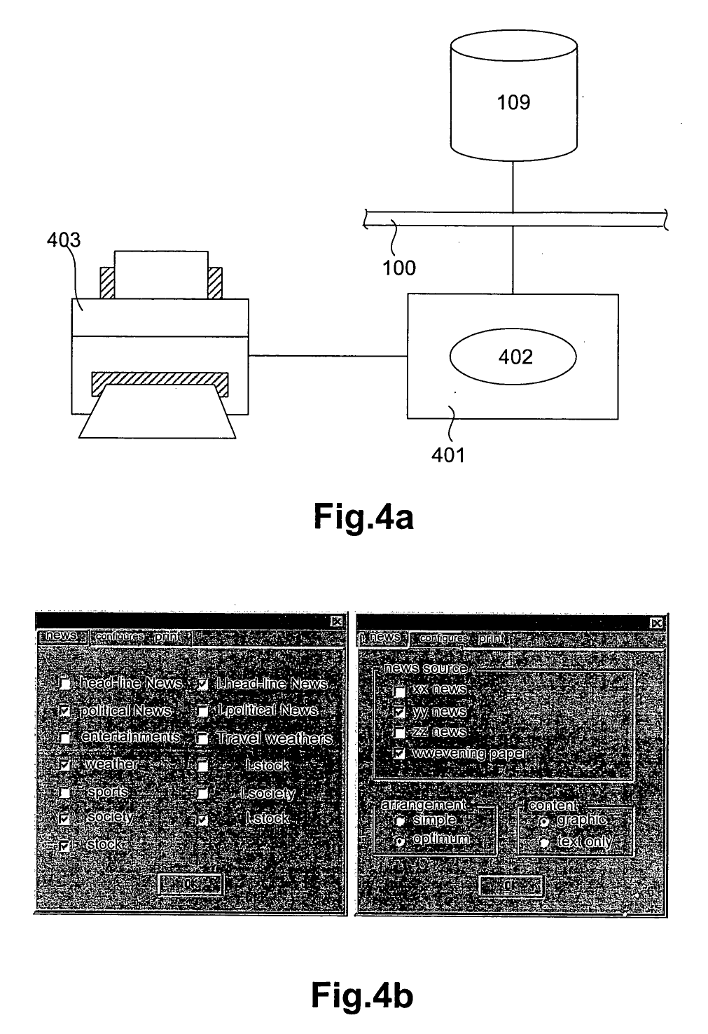

FIG. 4a shows a schematic diagram of another embodiment of the present invention. In this embodiment, database 109 connects to a personal computer 401 via network 100. The personal computer 401 includes a setting software 402 for users to select the information and typesetting that they prefer. FIG. 4b shows a schematic diagram of the software interface of the functional-key instruction setting in the embodiment of FIG. 4a. As shown in FIG. 4b, users can choose information provided by database 109 via the setting software 402, such as weather forecasts, news items and stock quotations. Users follow their needs to choose information and print the specific information 15 through output apparatus 403.

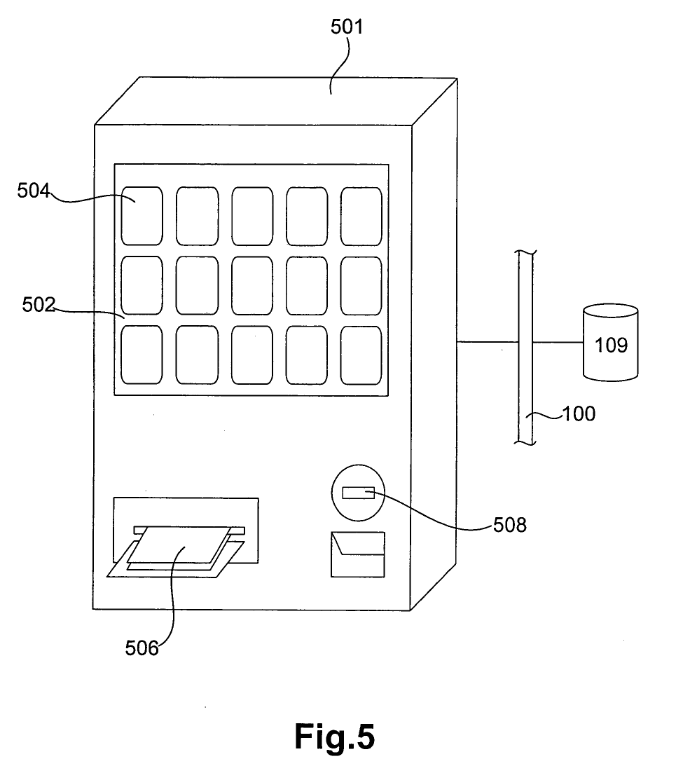

FIG. 5 shows a schematic diagram of another embodiment of the present invention. As shown in FIG. 5, the output apparatus 101 is a newsvendor 501. The newsvendor 501 connects to a database 109 via the network 100. After users put coins in the slot 508, they can select news type on the control panel 502, and press a keystroke 504 to output the specific information 15 on papers from the outlet 506.

While the invention has been described in connection with what is presently considered to be the most practical and preferred embodiments, it is to be understood that the invention is not to be limited to the discovered embodiments. The invention is intended to cover various modifications and equivalent arrangement included within the spirit and scope of the appended claims.

1. A method for outputting a specific information by functional-key instruction via an output apparatus, the specific information being saved in a database, the output apparatus including a network connection device, a processor, and an output unit, the output apparatus connecting to the database via a network by the network connection device, the processor respectively connecting to the network connection device and the output unit, the method comprising:
the processor receiving the functional-key instruction fetching the specific information from the database via the network connection device;
transmitting the specific information to the processor; and
transmitting the specific information from the processor to the output unit for outputting the specific information.

2. The method of claim 1, wherein the network connection device comprises a network card.

3. The method of claim 1, wherein the processor performs an operation over the specific information received.

4. The method of claim 3, wherein the operation comprises a typesetting procedure.

5. The method of claim 1, wherein the processor comprises a firmware.

6. The method of claim 1, wherein the processor comprises a software.

7. The method of claim 1, wherein the output apparatus comprises a printer.

8. The method of claim 1, wherein the output apparatus comprises a multifunction printer.

9. The method of claim 1, wherein the database comprises an internet information server.

10. The method of claim 1, wherein the database comprises an intranet information server.

11. An output apparatus, connecting to a network, for outputting a specific information saved in a database, the output apparatus comprising:
a network connection device respectively connecting to the network and the database;
a processor connecting to the network connection device; and
an output unit connecting to the processor;
wherein the processor fetches the specific information from the database via the network connection device, responsive to an instruction, and outputs the specific information via the output unit.

12. The output apparatus of claim 11, wherein the output apparatus further comprises a functional-key input interface for inputting the instruction.

13. The output apparatus of claim 11 wherein the instruction comprises a functional-key instruction.
